(19) United States
(12) Patent Application Publication
(10) Pub. No.: US 2012/0229096 A1
(43) Pub. Date: Sep. 13, 2012

(54) METHOD OF DEPOSITING SILICON ON CARBON NANOMATERIALS AND FORMING AN ANODE FOR USE IN LITHIUM ION BATTERIES

(75) Inventor: Gholam-Abbas Nazri, Bloomfield Hills, MI (US)

(73) Assignee: GM Global Technology Operations LLC, Detroit, MI (US)

(21) Appl. No.: 13/409,732

(22) Filed: Mar. 1, 2012

Related U.S. Application Data
(60) Provisional application No. 61/450,401, filed on Mar. 8, 2011.

(51) Int. Cl. H02J 7/00; H01M 4/82; H01M 4/583; B82Y 30/00

(52) U.S. Cl. 320/137; 429/231.8; 29/623.5; 977/948; 977/755

(57) ABSTRACT

Methods and devices for an anode formed from coated carbon nanofibers are provided. The carbon nanofibers having a cone geometry are coated with a silicon layer and a protective silicon oxide layer. The resulting composite material is suitable for high-capacity electrodes in lithium ion batteries. The electrodes incorporating the coated carbon nanofibers have improved rate capacity and decreased initial cycle irreversibility.

### CROSS-REFERENCE TO RELATED APPLICATIONS

This application claims the benefit of U.S. Provisional Application No. 61/450,401, filed on Mar. 08, 2011. The disclosure of the above application is incorporated herein by reference in its entirety.

This application is related to U.S. patent application Ser. No. __/___,___ (Attorney Ref. No. P014813 (8540S-000009)) filed on ___,__ 2012. The disclosure of the above application is incorporated herein by reference in its entirety.

### FIELD

The present disclosure relates to methods of depositing silicon on carbon nanomaterials and methods of forming an anode for use in lithium ion batteries.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The selection of battery materials includes considerations such as the desired power output for and any size limitations of the particular device incorporating the battery. With rechargeable batteries, capacity and rate capability or the rate at which the battery receives and delivers an electrical charge is also considered. In electric vehicles or other high-power applications, both the capacity and rate capability are the major priorities because of the extended range and high charge/discharge rates demanded by these applications.

With respect to lithium ion batteries, there is a loss of capacity and rate capability because after the initial charge—discharge cycles of new battery, there is an “initial cycle irreversibility” or a loss of 10 to 50% of available lithium ions. Thus, the initial cycle irreversibility decreases storage capacity of the battery for subsequent charges and discharges. To compensate for the initial cycle irreversibility and decrease in storage capacity, the battery size may be increased. As another option, alternate electrode systems may be used that modify the type of negative electrode in the system. However, these compensations and alternate electrode systems have shortcomings and provide technical barriers for commercialization of an optimized battery.

### SUMMARY

This section provides a general summary of the disclosure, and is not a comprehensive disclosure of its full scope or all of its features.

In various embodiments, the present teachings provide an electrode for a lithium ion battery. The electrode includes a plurality of coated carbon nanofibers including a carbon nanofiber core, a silicon layer over at least a region of the carbon nanofiber core, and a protective layer over at least a region of the silicon. A substrate supports the plurality of coated carbon nanofibers.

In still other embodiments, the present teachings provide methods of preparing an anode for a lithium ion battery. A plurality of coated carbon nanofibers comprising a carbon nanofiber core coated with a silicon layer and a silicon oxide layer are distributed on a substrate. The substrate is shaped to the contour of an anode.

In further embodiments of the present teachings, methods of decreasing initial cycle irreversibility of a lithium ion battery are provided. A lithium ion battery is charged with a source of lithium ions. The lithium ions are distributed to an anode made of a coated carbon nanofiber including a carbon nanofiber core having a silicon layer and a silicon oxide layer. Expansion of the silicon layer is mitigated by the silicon oxide layer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a coated carbon nanofiber according to various aspects of the present teachings;

FIG. 2 depicts an exemplary battery;

FIGS. 3A-3C depict a process of coating a carbon nanofiber according to various aspects of the present teachings;

FIGS. 4A-4B depict aspects of the coated carbon nanofiber according to various aspects of the present teachings;

FIGS. 5A-5B depict silicon modification after charge and discharge cycles according to various aspects of the present teachings;

FIG. 6 depicts images of the relative carbon concentration on a coated nanofiber according to various aspects of the present teachings; and

FIGS. 7A-7B depict the energy capacity and cycling efficiency according to various aspects of the present teachings.

Corresponding reference numerals indicate corresponding parts throughout the several views of the drawings.

### DETAILED DESCRIPTION

Example embodiments will now be described more fully with reference to the accompanying drawings.

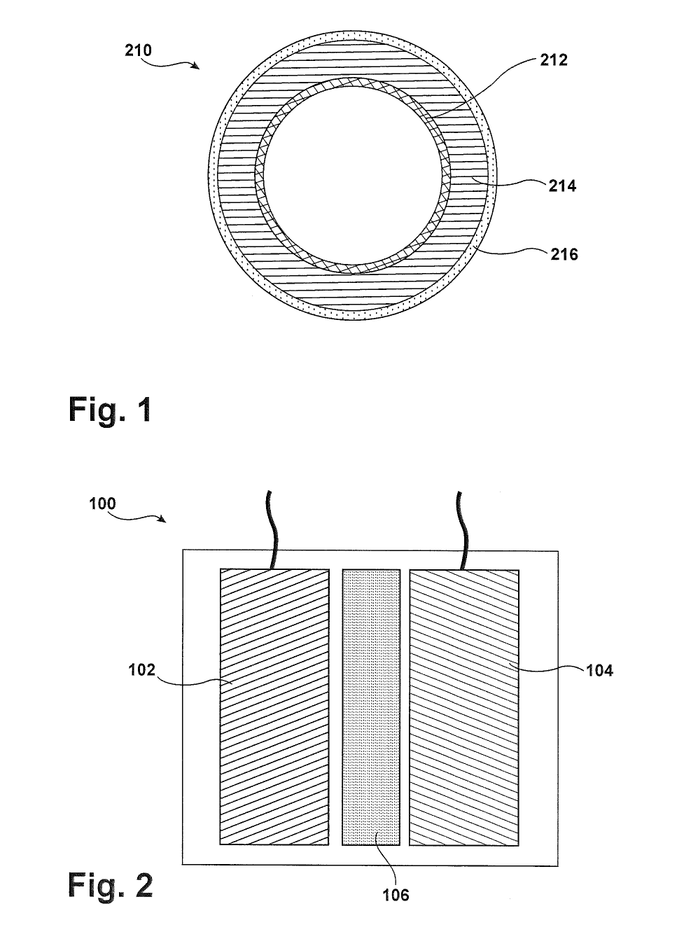

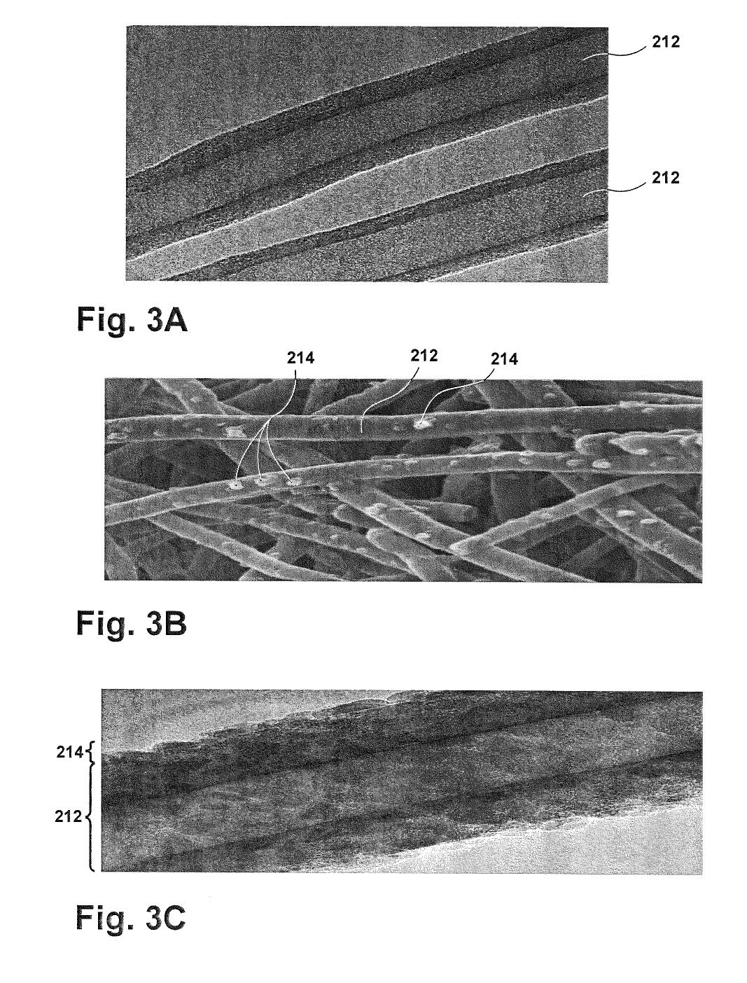

With reference to FIG. 1, the present teachings generally relate to coated carbon nanofibers 210 formed of a carbon nanofiber core 212 coated with a silicon layer 214 and a silicon oxide layer 216 and related methods of use. In various embodiments, the coated carbon nanofibers 210 are used as part of a battery 100 as generically depicted in FIG. 2. The battery 100 includes the anode 102, a cathode 104, and a separator 106 containing electrolyte. While the battery 100 of FIG. 2 is a simplified illustration, exemplary battery systems include lithium based batteries, silicon based batteries, lithium-sulfur systems, and lithium-air systems. The electrode described in the present teachings can be used as an anode in all lithium based batteries using metallic lithium or alternative anodes such as carbonaceous and graphitic anodes, oxides, nitrides, phosphides, and organic compounds.

Anodes 102 formed according to the present teachings provide increased capacity, increased energy density, improved electrical connectivity to the electrode, and improved stability of the battery. Notably, the instant anodes 102 and related methods provide a significantly increased rate capability, provide a faster charging time, and protect the system against parasitic reactions with the electrolyte. This is particularly beneficial for lithium batteries and for high-energy applications. The anode significantly reduces the irreversible capacity loss during initial charge-discharge cycles.

At the outset, a description of the materials is provided followed by a description of the methods of forming and using the materials. Turning to FIG. 1, the coated carbon nanofibers 210 include a carbon core 212, a silicon layer 214, and a silicon oxide layer 216. In various embodiments, the carbon core 212 has a diameter of from about 50 to about 250 nanometers. In still other embodiments, the carbon core 212 has a diameter of from 70 to 100 nanometers. The carbon core 212 is elongated and in various embodiments may have an aspect ratio of from about 200 to about 3000 (with respect to the diameter) or from about 500 to about 600, including all sub-ranges. The dimensions of the carbon nanofiber provide an increased surface area up to 50-100-fold greater than the surface area in traditional graphite materials used as electrodes.

The carbon core 212 is a hollow stacked-cone configuration with rough surface morphology that is markedly different from the smooth surface configuration of single wall carbon nanotubes (SWCNT). The stack-cone geometry facilitates cone-in-cone gliding. It is believed that the area gliding may relax the interfacial stress such that contact of the silicon on the carbon nanofibers will remain during alloying/de-alloying of silicon with lithium. In addition, the exposed interlayer of stacked graphene cones with silicon facilitates lithium insertion between the graphene cone to accommodate and protect the anode 102. Additional details on the carbon core 212 are provided in U.S. Patent Application Publication No. 2009/0294736 to Burton et al., which is incorporated herein by reference.

The silicon layer 214 has a thickness of from about 20 to 70 nanometers in various embodiments. In still other embodiments, the silicon layer 214 has a thickness of from about 35 to about 50 nanometers. It is understood that the silicon layer can cover the entirety of the carbon core 212 or discrete sections of the carbon core 212. In various embodiments, the coverage is from about 10 to about 100%, including all sub-ranges. The silicon also coat the inner surface of the carbon nanofiber hollow core.

The capacity of the coated carbon nanofiber 210 is tuned by controlling the thickness of the silicon layer 214. If the silicon layer 214 is too thick, there is an inadequate cyclability or charging and discharging of the battery. Appropriate selection and preparation of the silicon layer 214 are important because of the large volume that alloys experience during incorporation and release of large amounts of lithium during charge and discharge. For example, silicon undergoes over a 300% volume expansion when fully charged. Where the silicon is particulate form, the particles may migrate or fragment as a result of the volume changes. This isolates the silicon from electrical contact with the rest of the battery 100. The net result is rapid loss of capacity upon cycling. The instant teachings utilize amorphous and open structure silicon on the carbon core 212. This prevents migration of the silicon particles and helps the system to achieve excellent cyclability.

To protect the silicon layer 214, a silicon oxide layer 216 is coated thereon. The silicon oxide layer 216 has a thickness of from 1 nanometer to 20 nanometers in various embodiments, including all sub-ranges. In still other embodiments, the silicon oxide layer 216 has a thickness of about 5 nanometers. It is understood that the silicon oxide layer 216 can cover the entirety of the silicon layer 214 or discrete regions (stripes, spots, or random pattern, as non-limiting examples) of the silicon layer 214. It is further understood that, in certain embodiments and/or depending on the coating distribution, the silicon oxide layer 216 directly contacts the carbon core 212. In various embodiments, the coverage is from about 10 to about 100%, including all sub-ranges. It is further understood that silicon oxide layer has a compositionally graded interface with silicon layer, with lower oxygen concentration at the silicon oxide/silicon interface and hig oxygen concentration at the silicon/electrolyte interface.

The silicon oxide layer 216 provides better stability of the battery 100 because it prevents capacity drop during extended charge-discharge cycling and during long-time storage of the charged battery. The silicon oxide layer 216 serves as a protective layer that does not grow or substantially change in size over multiple charge and discharge cycles. The silicon oxide layer 216 of the instant teachings reduces initial cycle irreversibility to a less than about 10%. While silicon oxide is detailed in the instant disclosure as providing the above features, other protective layers such as nitrides, phosphides, borides, oxides phosphates, borates, various organics and the like are also suitable as the protective layer and may be used instead of or in addition to the silicon oxide.

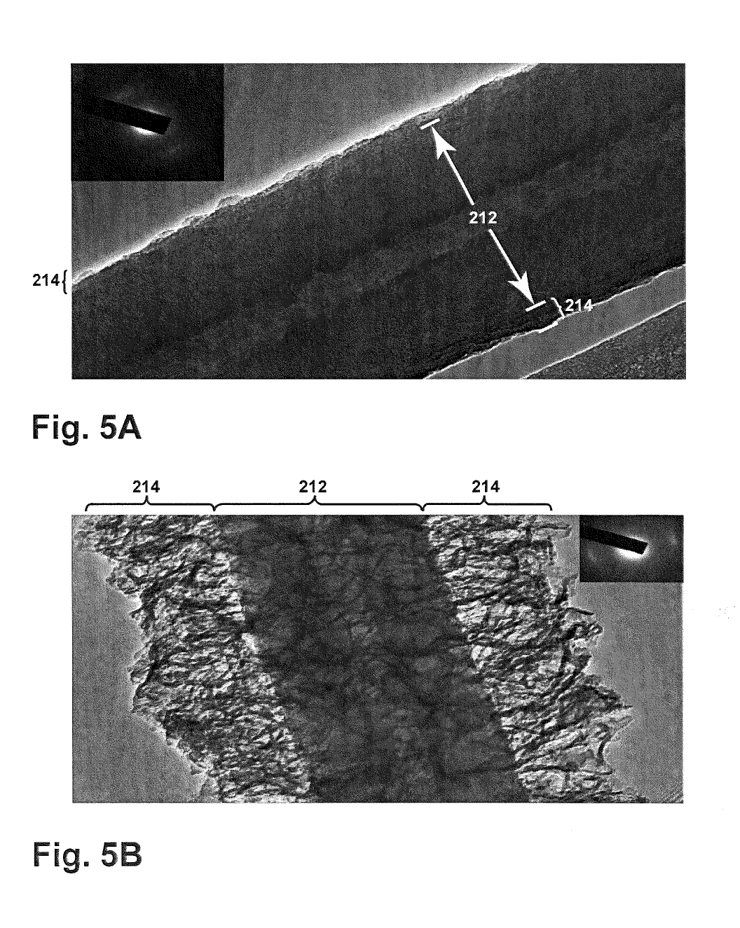

In various embodiments, and as depicted in FIG. 4B as will be detailed later herein, there is a gradient between the interfaces of some or all layers 212, 214, and 216 as shown in FIG. 1. For example, at an outer surface of the carbon core 212, there can be a mixed interface of carbon and silicon from the silicon layer 214. As the silicon layer 214 increases in thickness, the layer no longer includes the carbon and is silicon. Similarly, at the outer surface of the silicon layer 214, there can be a mixed interface of silicon and silicon oxide from the silicon oxide layer 216. As the silicon oxide layer 216 increases in the thickness, the layer no longer includes the silicon from silicon layer 214.

This graded feature or graded interface(s) prevents cracking of the materials that would occur due to a sharp interface between the layers 212, 214, and 216. As stated above, silicon expands significantly during alloying or the lithiation process which in turn generates significant stress at the silicon and carbon nanofiber interface. The gradient reduces those stresses. The stresses are further decreased by the graded silicon oxide layer 216.

In still other embodiments, an adhesion promoting layer (not depicted) is optionally used to secure the silicon layer 214 to the carbon core 212 and/or to secure the silicon layer 214 to the silicon oxide layer 216. Exemplary adhesion promoting layers include materials that have an adequate ability to adhere to adjacent layers. The adhesion promoting layers include various metals, metal alloys, organic materials, and/or inorganic materials. In various embodiments, the adhesion promoting layers include metals, polymers, and combinations thereof. For example, in various embodiments a titanium adhesion promoting layer is used because titanium demonstrates adhesion to both carbon and silicon.

To form the coated carbon nanofiber 210, the carbon core 212 with the stack-cone configuration is heat treated in air at a temperature from about 500 to about 750 degrees C. to remove amorphous or loosely bound carbon. The heat treatment provides more graphitic fibers and also provides roughness on the carbon core 212 to better adhere the silicon layer 214. It is understood that higher surface roughness also can be achieved by other methods such as heat treating the carbon core with other reactive gases, and physical methods such as by ion milling.

Next, silicon is deposited on the prepared carbon core 212 to form the silicon layer 214. The silicon layer 214 is deposited by decomposition of a silicon starting material, such a silane or an organosilane, at a temperature of about 550 to about 750 degrees C. In various embodiments, the decomposition is achieved in a tube reactor or furnace. In various embodiments, the flow rate for the silicon is from about 50 cubic centimeters per minute to about 300 cubic centimeters per minute, including all sub-ranges. In various other embodiments, the flow rate is about 100 cubic centimeters per minute. These parameters control the amorphicity of the silicon.

In various other embodiments, the silicon layer 214 is deposited using a fluidized bed reactor. This option is useful and cost-efficient where there is a massive amount of carbon core 212 to be coated. In still other embodiments, silicon hydride is used to form the silicon layer 214. In such an embodiment, there is further cost-reduction because the excess heat generated during carbon nanofiber preparation can be used to decompose the silicon hydride. It is understood that the silicon sources listed here are non-exhaustive and other sources are within the scope of the present teachings.

To prepare the silicon oxide layer 216, air or oxygen is introduced into the flow gas used to create the silicon layer 214. The temperature in the tube reactor or furnace is from about 400 to about 750 degrees C. or from about 400 to about 650 degrees C., including all sub-ranges. The air provides a reaction on the silicon layer 214 to provide the silicon oxide material.

Optionally, in still other embodiments, an additional protective layer is used in connection with the silicon oxide layer 216. For example, there may be a pre-treatment with air, ammonia, borane, or other gaseous species and compounds to further stabilize the electrode/electrolyte interface, and improve long term charge-discharge cycling.

To prepare the anode 102 of the present teachings, the coated carbon nanofibers 210 are mixed with a binder. In various embodiments, the binder is a solid or a liquid. In still other embodiments, the binder is an elastomer. Where a dissolved liquid elastomer is used, the coated carbon nanofibers 210 and the binder form a slurry which is cast on a supporting surface, such as a copper foil or a carbon paper, as non-limiting examples. The slurry is dried and the support is cut into the desired shape of the anode 102 or the support has a pre-formed shape of the anode 102. In other embodiments, the silicon coated carbon fiber is formed in a preformed mat configuration and used in the battery 100 without a copper support. In still other embodiments, a plurality of carbon cores 212 are disposed on the support and subsequently, the silicon layer 214 and silicon oxide layer 216 are deposited thereon.

The anode 102 is incorporated into a battery 100. The battery 100 is charged with an electrolyte as the source of lithium ions. The electrolyte and lithium ions come into contact with the anode 102 to facilitate the oxidation-reduction reactions that occur at the anode 102. When the electrolyte enters the coated carbon nanofibers 210 and the battery 100 is operating, the expansion of the silicon layer 214 that occurred in previous systems is significantly mitigated by the silicon oxide layer 216 as detailed above. Surprisingly, the various methods and devices of the present teachings reduce initial cycle irreversibility by from about 10% to about 100%, including all sub-ranges, or from about 10% to about 70%, including all sub-ranges, as compared to other systems. In turn, this markedly improves the rate capability, provides high capacity, and facilitates large scale use and commercialization of systems incorporating the instant anodes 102. In various embodiments, the rate capacity remains relatively consistent (from about 0.1% to less than about 20% decrease, including all sub-ranges) over from 10 to 10,000 charge and discharge cycles, including all sub-ranges, as will be detailed in the Examples section.

Further, the improved performance of the instant anodes 102 is attributed to the various unique features disclosed herein, alone or in various combinations. The lithium charge storage capacity using anodes according to the present teachings is from 3 to 5 times greater than that of lithium carbon anode. This is further magnified when the coated carbon nanofiber 210 is formed on a paper-type electrode without the use of a copper current collection. In such embodiments, there is an 8- to 12-fold capacity advantage as compared to a copper current collector. By using free-standing and/or pre-formed paper electrodes, there is significant cost reduction and improvement of battery gravimetric energy density.

### EXAMPLES

Improvements in the retention of the reversible capacity were achieved through refinements in the deposition process. Scanning electron microscopy (SEM), high-resolution transmission electron microscopy (HRTEM), and x-ray diffraction (XRD) examinations of negative electrode materials according to the present teachings revealed that the benefits of coating an amorphous silicon with nanoscale thickness. Closer examination revealed that the best performing electrodes were bonded to the carbon substrate through a graded interface where the ratio of carbon and silicon gradually changes from carbon nanofiber substrate to the surface of the coating. There is evidence that the graded interface creates a robust bonding to withstand severe expansions and contractions of the silicon as it undergoes lithiation and de-lithiation. Evidence of this behavior is revealed in transmission electron microscopy (TEM) analysis of the silicon coated carbon nanofiber 210 after 100 cycles.

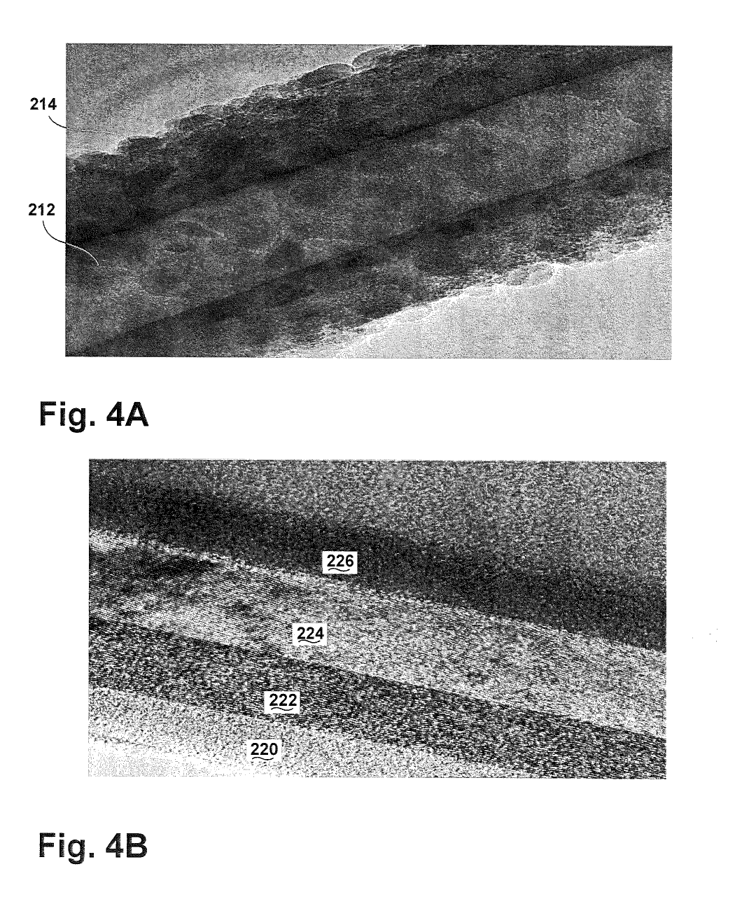

FIG. 3A shows a TEM micrograph of baseline carbon nanofiber 212 prior to silicon coating. As shown in FIGS. 3B and 3C, SEM and TEM micrographs show nanoscale amorphous silicon attached to the surface of electrically conductive carbon nanofiber. At low loadings, as shown in FIG. 3C, the silicon 214 is deposited as small islands or nodules on the surface of the nanofiber. At higher loadings, the silicon is deposited in a manner which produces a high surface area coating for rapid lithiation/de-lithiation for higher power capability higher resolution TEM of a single strand of the silicon carbon nanofiber composite.

FIG. 4A shows the HRTEM images of silicon-carbon negative electrode alloy materials made of the coated carbon nanofibers 210. FIG. 4B shows an end-on view show the resulting ring structure. The wall of hollow and coated carbon nanofiber 210 has a compositionally graded nanostructure that is useful for adhering silicon. As shown, there is a presence of silicon (labeled element 220), silicon carbide (labeled element 222), carbon with low amounts of silicon (labeled element 224), and carbon (labeled element 226).

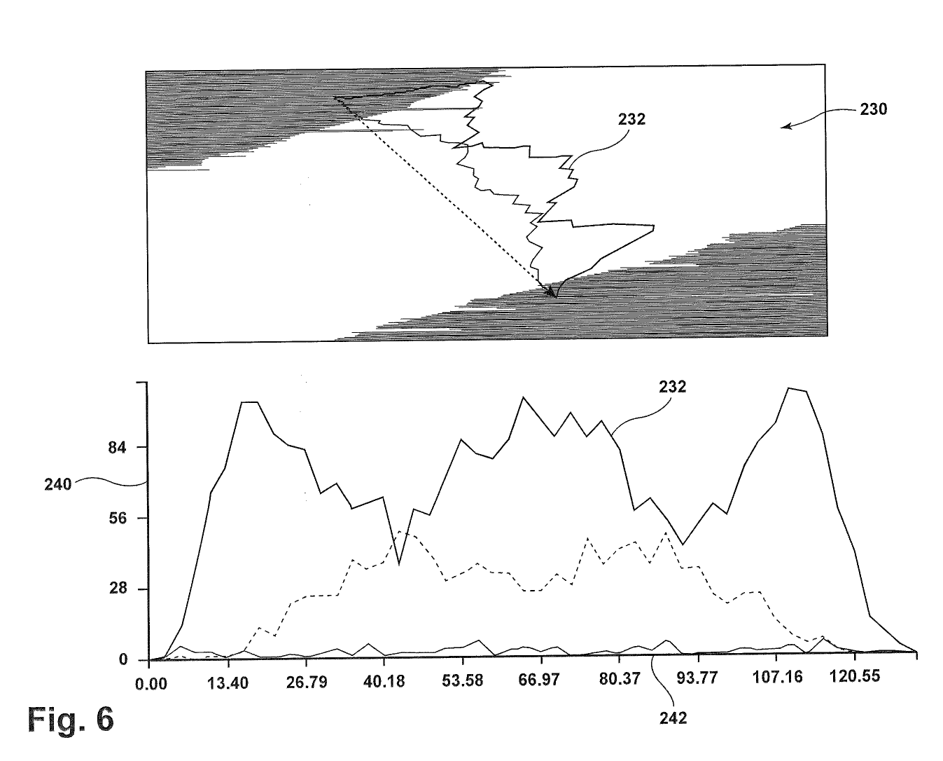

FIG. 5A shows a TEM image of coated carbon nanofiber 210 having a thin layer of silicon prior to electrochemical cycling. FIG. 5B shows a TEM image of silicon coating after 100 electrochemical deep charge-discharge cycles. The coated nanofiber 210 at FIG. 5B has a scale of 2.5-fold greater than the scale of FIG. 5A. In other words, the scale for FIG. 5A was 20 nanometers per unit measurement while the scale for FIG. 5B was 50 nanometers per unit of measurement. These images clearly show that the silicon has expanded but is still chemically bonded, and electrically connected, to the carbon nanofiber after 100 charging/discharging events.

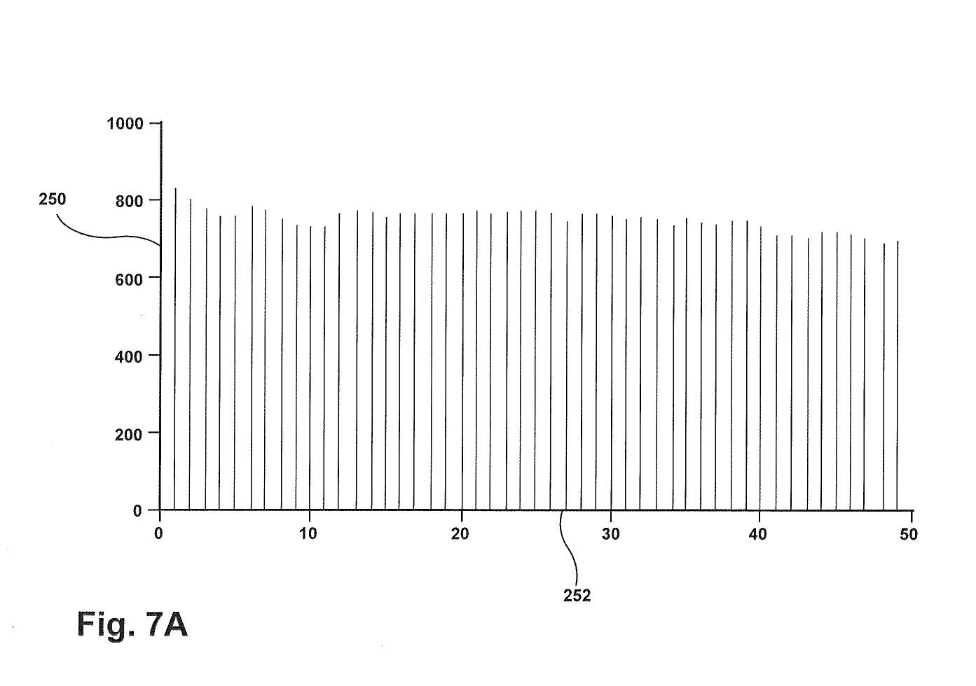

FIG. 6 provides a TEM (labeled 230) image and an energy dispersive x-ray spectroscopy (EDS) (labeled 232) line scan showing the relative concentration of carbon and silicon of silicon coated carbon nanofiber 210 sample. The EDS performed on the silicon-coated carbon nanofiber 210 supports the high resolution TEM and SEM microscopy results which indicated the presence of the silicon on the interior surface of the carbon nanofiber 212. The EDS line scans on the cross section of the coated carbon nanofiber reveal that the silicon concentration is highest at the midpoint of the scan. This result indicates that the silicon is deposited on the interior and exterior of the nanofiber. As shown in FIG. 6, similar lines scans performed on a sample of cycled silicon coated carbon nanofiber reveal that the silicon deposited along and within the width of the carbon nanofiber (represented in nanometers on the X-axis labeled element 242) is still present after 100 charge—discharge cycles (represented on the Y-axis labeled element 240).

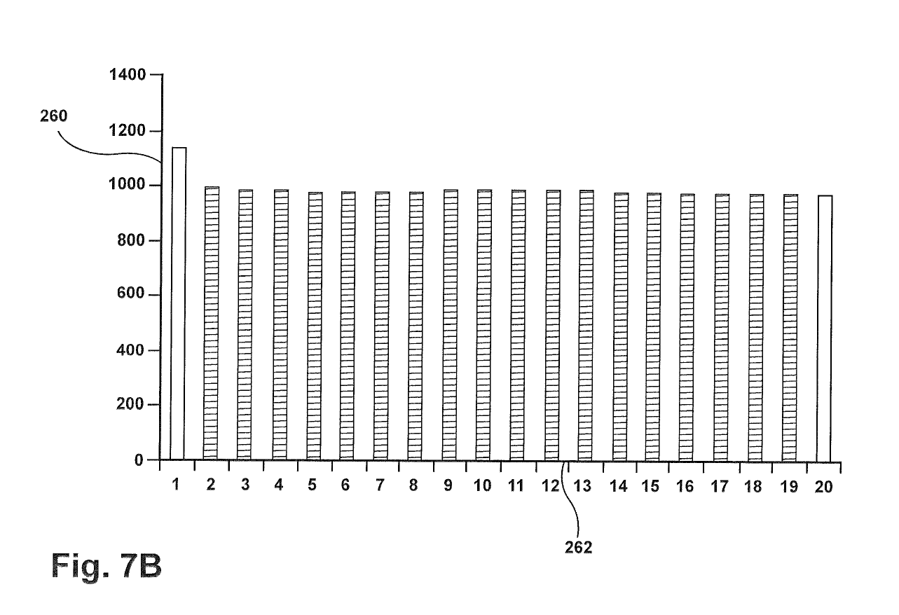

Turning to FIGS. 7A and 7B, composite negative electrodes manufactured at the laboratory scale showed exceptionally high energy capacities of 1000 to 1200 mAh/g (represented on the Y-axis labeled elements 250 and 260, respectively) and excellent cycling efficiencies (represented by the number of cycles shown on the X-axis labeled elements 252 and 262, respectively). The cycling efficiency of the silicon and carbon nanofiber composite negative electrode was further enhanced when cycled in a full cell configuration against conventional positive electrodes or cathodes.

The composite negative electrode samples were produced with a high level of reproducibility and specific capacity. The cycling efficiency steadily improved through modifications in reactor parameters during silicon deposition and surface treatment of the deposited silicon. Quality control methods were introduced and refined to ensure consistent quality from batch to batch. As illustrated in FIGS. 7A and 7B, negative electrode powders including nanoscaled fibers exhibited excellent capacity retention and very low irreversible capacity during first cycle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for a lithium ion battery comprising:
a plurality of coated carbon nanofibers comprising:
a carbon nanofiber core;
a silicon layer over at least a region of the carbon nanofiber core;
a protective layer over at least a region of the silicon; and
a substrate supporting the plurality of coated carbon nanofibers.

2. The electrode of claim 1, wherein the carbon nanofiber has a diameter of from about 50 nanometers to about 250 nanometers.

3. The electrode of claim 1, wherein the silicon layer has thickness of from about 20 nanometers to about 70 nanometers.

4. The electrode of claim 1, wherein the protective layer has a thickness of from about 1 nanometer to about 20 nanometers.

5. The electrode of claim 1, wherein the protective layer is selected from the group consisting of a silicon oxide, a nitride, a phosphides, a boride, a phosphate, a borate, organic compounds, carbonaceous materials, and combinations thereof.

6. The electrode of claim 5, wherein the protective layer comprises silicon oxide.

7. The electrode of claim 1, wherein there is a graded interface between at least two of the carbon nanofiber, the silicon layer, and the protective layer.

8. The electrode of claim 1, wherein the electrode forms an anode.

9. A method of preparing an anode for a lithium ion battery comprising:
distributing a plurality of coated carbon nanofibers onto a substrate, the carbon nanofibers comprising a carbon nanofiber core coated with a silicon layer and a silicon oxide layer; and
shaping the substrate to the contour of an anode.

10. The method of claim 9, further preparing a slurry of a binder and the plurality of coated carbon nanofibers.

11. The method of claim 9, further incorporating the anode into a lithium ion battery.

12. The method of claim 11, further comprising charging the battery with a source of lithium ions and reducing initial cycle irreversibility of the lithium ions.

13. The method of claim 12, wherein the initial cycle irreversibility is reduced by from about 10% to about 100%.

14. The method of claim 13, further comprising restricting expansion of the silicon layer with the silicon oxide layer.

15. The method of claim 9, wherein the substrate is a carbon paper.

16. The method of claim 9, further comprising forming a graded interface between at least one of the carbon nanofiber and the silicon layer and the silicon layer and the silicon oxide layer.

17. A method of decreasing initial cycle irreversibility of a lithium ion battery comprising:
charging a lithium ion battery with a source of lithium ions;
distributing the lithium ions to an anode comprising a coated carbon nanofiber comprising a carbon nanofiber core having a silicon layer and a silicon oxide layer; and
mitigating expansion of the silicon layer with the silicon oxide layer.

18. The method of claim 17, further comprising adhering together the carbon nanofiber, the silicon layer, and the silicon oxide layer during operation of the lithium ion battery through a first graded interface between the carbon nanofiber and the silicon layer and a second graded interface between the silicon layer and the silicon oxide layer.

19. The method of claim 17, wherein the initial cycle irreversibility is reduced by from about 10% to about 100% as compared to a lithium carbide anode.

20. The method of claim 17, wherein a charge capacity of the anode experiences less than about a 20% decrease over at least 50 charge and discharge cycles.
